(19) United States
(12) Patent Application Publication
(10) Pub. No.: US 2020/0052399 A1
(43) Pub. Date: Feb. 13, 2020

(54) APPARATUS AND METHOD FOR HIGH ENERGY TRANSFER BETWEEN MAGNETIC RECORDING HEAD AND RESONANT ANTENNA

(71) Applicant: NEW YORK UNIVERSITY, New York, NY (US)

(72) Inventor: JACEK GOSCINIAK, LODZ (PL)

(21) Appl. No.: 16/539,016

(22) Filed: Aug. 13, 2019

Related U.S. Application Data
(60) Provisional application No. 62/718,125, filed on Aug. 13, 2018.

(51) Int. Cl. H01Q 5/10; H01Q 1/22; G11B 5/39

(52) U.S. Cl. CPC H01Q 5/10; G11B 5/3967; H01Q 1/22

(57) ABSTRACT

An apparatus for recording information on a magnetic medium can be provided, which can include, for example, a plasmonic transducer(s)/waveguide and a resonant antenna(s) of different forms and shapes spaced at a distance from the plasmonic transducer(s)/waveguide, where the resonant antenna(s) can be configured to receive or maintain the magnetic medium thereon. The resonant antenna(s) can be in the form of nanorods, spheres, or other plasmonic structures able to support a localized surface plasmon. The resonant antenna(s) can be achieving either by structuring the metal below recording media or by drop-casting/depositing nanoparticles below a recording media. The size of the nanoantenna can be based on the achieving high field enhancement between plasmonic transducer/waveguide and matching an impedance of the transducer(s).

### CROSS-REFERENCE TO RELATED APPLICATION(S)

This application relates to and claims priority from U.S. Patent Application No. 62/718,125, filed on Aug. 13, 2018, the entire disclosure of which is incorporated herein by reference.

### FIELD OF THE DISCLOSURE

The present disclosure relates generally to magnetic recording, and more specifically, to exemplary embodiments of exemplary apparatus and method for a high field enhancement between a magnetic recording head (plasmonic transducer/waveguide) and a resonant antenna, for example, in magnetic recording(s).

### BACKGROUND INFORMATION

Plasmonics, with its capability of subwavelength confinement of electromagnetic energy, has become a driving force for progress in the area of nanophotonics. The phenomenon originates from strong coupling of photons with free-electrons in metal. This supports a wave of charge density fluctuations on the surface of the metal that creates a subwavelength oscillating mode called a surface plasmon. (See, e.g., Reference 1). Such strong light-matter interaction leads to strong confinement of light (see, e.g., References 1 and 2) and a high electromagnetic field enhancement. (See, e.g., References 2-3).

Thus, it may be beneficial to provide an exemplary apparatus and method for a high field enhancement between a plasmonic transducer/waveguide and a resonant antenna in magnetic recording(s), which can facilitate high areal density, high temperature gradient in the recording media, and high power efficiency in current systems and methods.

### SUMMARY OF EXEMPLARY EMBODIMENTS

An apparatus for recording information on a magnetic medium can be provided, which can include, for example, a transducer(s) or a waveguide(s), and a resonant antenna(s) spaced at a distance from the transducer(s) or the waveguide(s), where the resonant antenna(s) can be configured to receive or maintain the magnetic medium thereon. The resonant antenna can include a plurality of nanotubes or a plurality of nanorods or a plurality of nanospheres or any other shapes that are able to support a localized surface plasmon mode. A size of the plurality of nanotubes or the plurality of nanorods or the plurality of nanospheres or any other shapes that are able to support a localized surface plasmon modes can be chosen to ensures a high impedance match with the transducer(s) or the waveguide(s). The resonant(s) antenna can include a plurality of metallic nanoparticles configured to support at least dipole plasmonic mode. The distance can be chosen to ensure optimum working conditions (e.g., about 7 nanometers). The transducer(s) can be a plasmonic transducer(s).

In some exemplary embodiments of the present disclosure, the waveguide(s) can be a plasmonic waveguide(s). The apparatus can include the transducer(s) and the waveguide(s), and the transducer(s) can be supported by the waveguide(s). The transducer(s) and the waveguide(s) can be supported by a substrate. The resonant antenna(s) can be disposed on an underlayer, which can be disposed on a substrate. The transducer(s) can have a shape of a disk or any other shape that support a localized surface plasmon mode. The transducer can have a tapered end located on a side of the transducer(s) that can be adjacent to the resonant antenna(s).

In certain exemplary embodiments of the present disclosure, the resonant antenna(s) can include a plurality of resonant antennas, and each of the resonant antennas can be configured to receive or maintain a portion of the magnetic medium thereon. The resonant antenna(s) can be composed of, in part or fully, gold or any other metallic material. The magnetic medium can be a recording medium. The apparatus can have a uniform field distribution between the transducer(s) or the waveguide(s) and the resonant antenna(s). The magnetic medium can be a patterned medium.

Additionally, an exemplary method for recording information on a magnetic medium can include receiving or maintaining the magnetic medium by a resonant antenna(s), where the resonant antenna(s) can be spaced at a distance from a transducer(s) or a waveguide(s), and facilitating the recording of the information on the magnetic medium.

These and other objects, features and advantages of the exemplary embodiments of the present disclosure will become apparent upon reading the following detailed description of the exemplary embodiments of the present disclosure, when taken in conjunction with the appended claim.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1A is an exemplary diagram of an exemplary apparatus for the high field enhancement between the transducer and the resonant antenna formed by structuring a media below a recording material according to an exemplary embodiment of the present disclosure;

FIG. 1B is an exemplary diagram of an exemplary tapered plasmonic waveguide according to an exemplary embodiment of the present disclosure;

FIG. 2 is an exemplary diagram of two metal strips separated by a nanogap according to an exemplary embodiment of the present disclosure;

FIG. 3A is an exemplary diagram of a nanodisk and a dipole antenna according to an exemplary embodiment of the present disclosure;

FIG. 3B is an exemplary diagram of a nanodisk and an image plain according to an exemplary embodiment of the present disclosure;

FIG. 4 is a further exemplary diagram of the exemplary apparatus for the high field enhancement between the transducer/waveguide and the resonant antenna formed by deposition of metallic nanoparticles below a recording material according to another exemplary embodiment of the present disclosure;

FIG. 5 is a cross-sectional view of the structure shown in FIG. 4 according to an exemplary embodiment of the present disclosure;

FIG. 6 is an exemplary diagram of metallic nanoparticles shown in FIG. 5 showing electric field orientation in the metallic nanoparticles under illumination and corresponding hot spot on top of the nanoparticle according to an exemplary embodiment of the present disclosure;

FIGS. 7A and 7B are exemplary images and associated graphs showing an electric field calculated at the center of a gap versus the wavelength performed for different length antennas according to an exemplary embodiment of the present disclosure;

FIGS. 8A and 8B are further exemplary images and associated graphs showing the calculated electric field according to a further exemplary embodiment of the present disclosure;

FIG. 9 is an exemplary flow diagram of an exemplary method for recording information on a magnetic medium according to an exemplary embodiment of the present disclosure; and

FIG. 10 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and accompanying numbered claims.

### DETAILED DESCRIPTION OF EXEMPLARY EMBODIMENTS

Optical antennas can provide an interface light and matter through transducing far-field radiation to highly localized hotspots. (See, e.g., References 5-8). An antenna can be characterized by a large normalized cross-section that facilitates a collection of an efficient electromagnetic energy from the incident radiation. This exemplary configuration can induce a large near-field enhancement that can facilitate transferring most of the energy into a small volume in the vicinity of the nanoantenna. To further increase the field enhancement, while still maintaining a high effective cross-section, a gap can be introduced between two resonant antennae with the field concentrated in the gap. In such an exemplary structure, the resonant properties of the gap antenna can be controlled by the localized surface plasmon resonances (“LSPRs”) supported by each of the antennas that can couple through the gap. The electric field amplitude in the gap can be based on its longitudinal component (e.g., parallel to the gap). The continuity condition of the normal components of the displacement field at the gap walls can provide a relation |E_{gap}|/|Eₐₙₜ|=εₘ(ω)/ε_{d}, where |E_{gap}|, |Eₐₙₜ| can be the field amplitude in the gap and inside the antenna and εₘ(ω), ε_{d} can be the permittivity of the metallic antenna and the electric medium in the gap. From this relation, where gold nanoantennas can be considered (ε_{Au}=−21+1.3i at λ=800 nm) with an air gap E (εₐᵢᵣ=1), an approximately 21-fold increase of the longitudinal electric field component inside the gap can be expected. The highly localized field can be attributed to the buildup of charges of opposite signs across the gap.

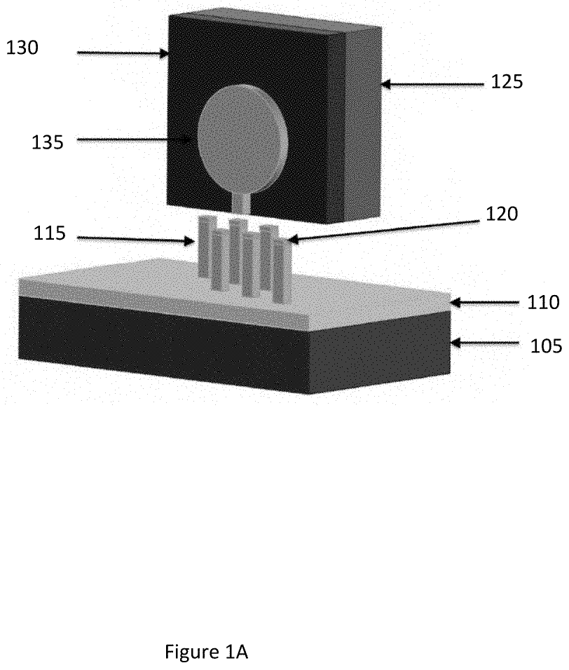

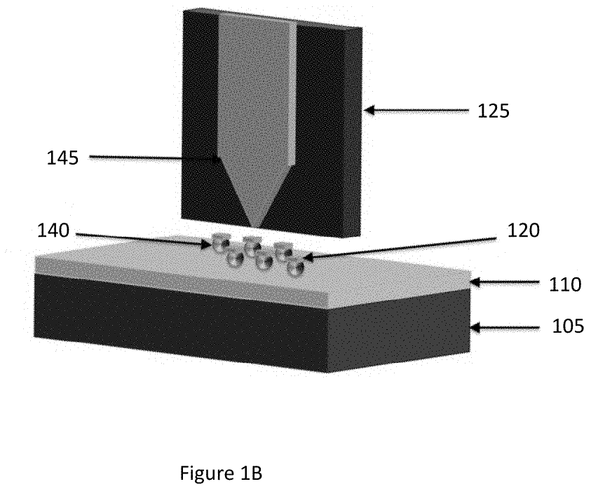

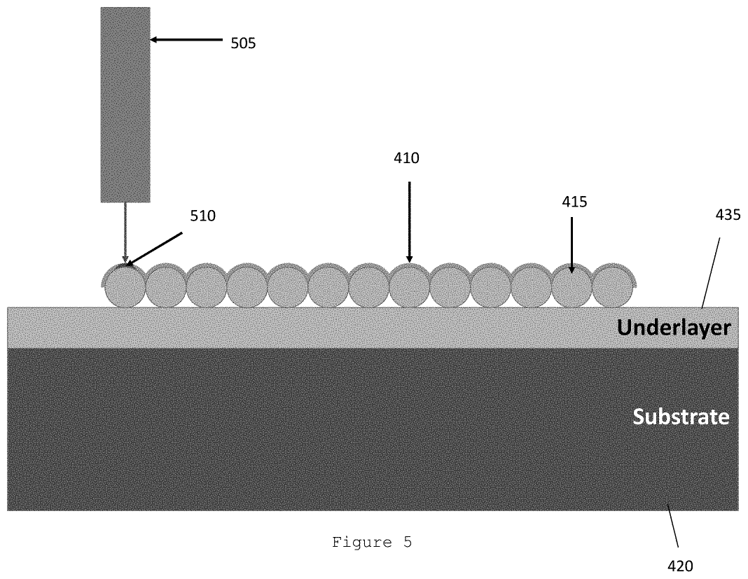

The exemplary apparatus, according to an exemplary embodiment of the present disclosure, can utilize the resonant antenna conditions to achieve further intensity enhancement in the gap and consequently high-power transfer to the recording media. (See, e.g., FIGS. 1 and 4). The exemplary recording media material can be deposited on the patterned media that can form a resonant antenna, or deposited below metallic nanoparticles, which can be based on the Bit Patterned Heat-Assisted Magnetic Recording (“BP HAMR”). In addition to the high field enhancement, the exemplary apparatus can ensure and/or facilitate a uniform field distribution in the gap that translates on the high temperature gradient in the recording media, which can be desired in HAMR technology. (See, e.g., References 14-18).

The exemplary apparatus, according to an exemplary embodiment of the present disclosure, can perform an efficient transfer of energy to the recording media deposited on top of an impedance-matched antenna across a gap. The light from an exemplary transducer, or tapered waveguide, can be combined with, and enhanced by, the resonance in the nanoantenna below facilitating a significant boost to the local field enhancement that can be evenly distributed over the gap volume. The resonant impedance matched excitation of the nanoantenna can include a significant local-field enhancement in the gap, and a substantial resonant decrease of back refection from a transducer or the tip of the taper. (See, e.g., Reference 13).

FIG. 1A shows an exemplary diagram of the exemplary apparatus which facilitates the high field enhancement between the transducer and the resonant antenna formed by structuring a media below a recording material according to an exemplary embodiment of the present disclosure. For example, as shown in FIG. 1A, a substrate 105 can support an underlayer 110 provided thereon. Underlayer 110 can include one or more antennas 115, which can include recording media 120 (e.g., one antenna can include one recording medium). A supporting substrate 125 can be provided which can support a waveguide 130, having transducer 135 disposed thereon.

FIG. 1B shows an exemplary diagram of an exemplary tapered plasmonic waveguide according to an exemplary embodiment of the present disclosure. For example, as shown in FIG. 1B, substrate 105 can have an underlayer 110 disposed thereon, similarly to the exemplary apparatus illustrated in FIG. 1A. One or more metal nanoparticles 140 can be provided on underlayer 110 which can have the recording medium disposed thereon (e.g., each metal nanoparticle can have a single recording medium disposed thereon). Substrate 125 can also be provided (similar to the substrate of FIG. 1A) which can include a tapered plasmonic waveguide 145, that can have a different shape than the shape of the waveguide and the transducer shown in FIG. 1A. Light can be coupled to the antenna across a gap in the form of either propagating surface plasmon (“SPP”) (see e.g., diagram shown in FIG. 1B) or LSPR (see e.g., diagram shown in FIG. 1A). The longitudinal component of the electric field at the termination of the plasmonic waveguide 130 and transducer 135 of FIG. 1A can couple to the one or more antennas 115 across a gap that can be designed to meet resonance conditions at the desired wavelength range. Thus, the nano-focusing in the transducer 135 can be combined with and enhanced by, the resonance in the antennas 115, facilitating further increases of the local field intensity enhancement in the gap.

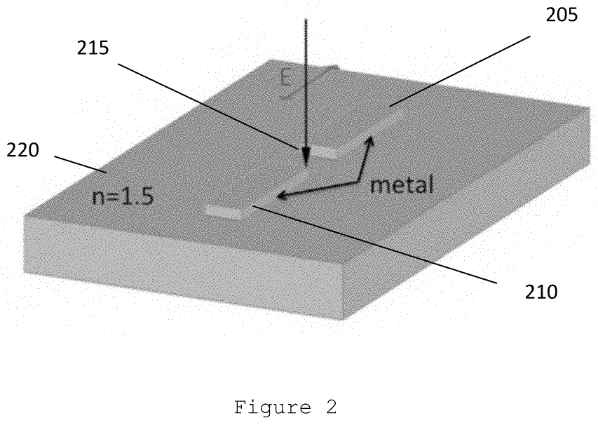

Exemplary operational principals can be similar to those of the feed gap structure, for example, a dimer antenna (See, e.g., diagram illustrated in FIG. 2), where light coupled to the structure from the top can be polarized along the long axis of the structure. In particular, FIG. 2 shows an exemplary diagram of two metal strips 205 and 210 on a dielectric substrate 220 with the incident polarization parallel to the longitudinal stripe, where the two metal stripes are separated by a nanogap 215 according to an exemplary embodiment of the present disclosure. The electric field component, normal to the gap, can be coupled to the resonant antenna across the gap, which can provide a significant electric field enhancement inside the gap.

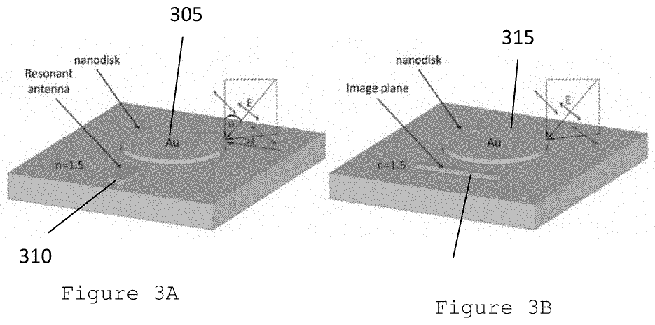

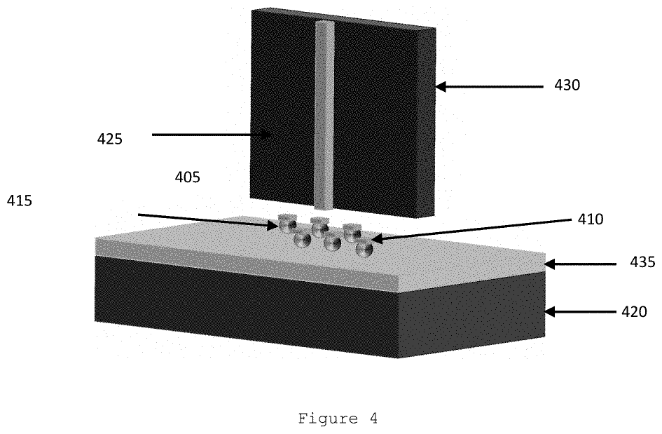

One of the exemplary dipole antenna, according to the present disclosure, can be replaced with a nanodisk, or any other plasmonic structure that can excite a dipole, quadrupole or higher-order resonant modes. (See, e.g., References 17 and 18). Simulations for a transducer and a nanorod placed on top of the glass substrate were performed and compared to a full three-dimensional case (See e.g., diagrams shown in FIGS. 1A and 1B), which generally requires sophisticated fabrication techniques. The exemplary simulation results can provide useful information, and the results can be easily implemented in real devices. One of the dipole antennae can be replaced by a plasmonic waveguide. To achieve a field enhancement in the direction of either a dipole antenna (see e.g., FIG. 3A) or an image plane (see e.g., FIG. 3B), light can be coupled to a nanodisk with a certain angle depending on the desired mode of a nanodisk at angle of φ=π/4=45°.

In particular, FIG. 3A shows an exemplary diagram of a nanodisk 305 and a dipole antenna (e.g., resonant antenna 310) according to an exemplary embodiment of the present disclosure, and FIG. 3B shows an exemplary diagram of a nanodisk 315 and an image plain 320 according to an exemplary embodiment of the present disclosure. For an exemplary simulation, and to assume a free space coupling of light to a transducer, the angle θ was kept constant at θ=π/2.25=80°. For such an angle, the dominant electric field component can be polarized along the side of the nanodisk that can excite the quadrupole mode. (See, e.g., References 19 and 20).

For example, all geometries discussed herein were investigated using a three-dimensional finite element method (“FEM”) simulations using the commercial software COMSOL Multiphysics. (See, e.g., Reference 19).

The resonant antenna below the recording media can be formed either by structuring a metal layer below a recording media (See e.g., diagrams shown in FIGS. 1A and 1B) or by deposition of metallic nanoparticles below a recording media (See e.g., diagram shown in FIG. 4) that can be in a different form and shape as long as resonant conditions are met. The antenna dimensions can be selected to achieve a high field enhancement between plasmonic transducer/waveguide and the antenna below. Both antenna dimensions and plasmonic transducer/waveguide dimensions can be chosen to facilitate a superior impedance match between plasmonic transducer/waveguide and the resonant antenna below providing high energy transfer to the recording media.

FIG. 4 shows an exemplary diagram of the exemplary apparatus according to another exemplary embodiment of the present disclosure which facilitates a high intensity enhancement in the gap 405 and, consequently, high power transfer to the recording media 410 with a metallic spheres drop 415 casted/deposited directly an underlayer 435, which is supported by supporting substrate 420 and recording material 410 deposited on top thereof. The drop-casted/deposited spheres 415 can function as a nanoantenna that can excite a localized plasmonic mode, providing rise to a field enhancement between plasmonic transducer/waveguide 425, which is supported by substrate 430 and the nanoantenna 415.

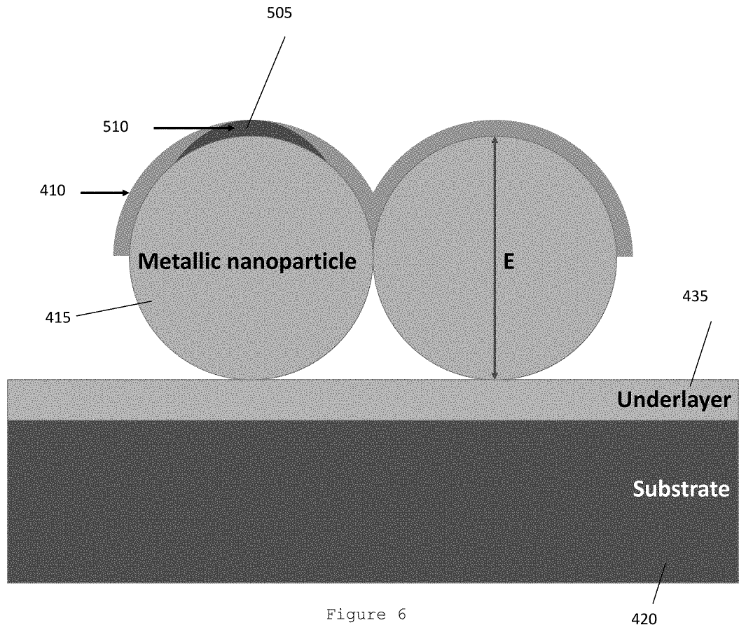

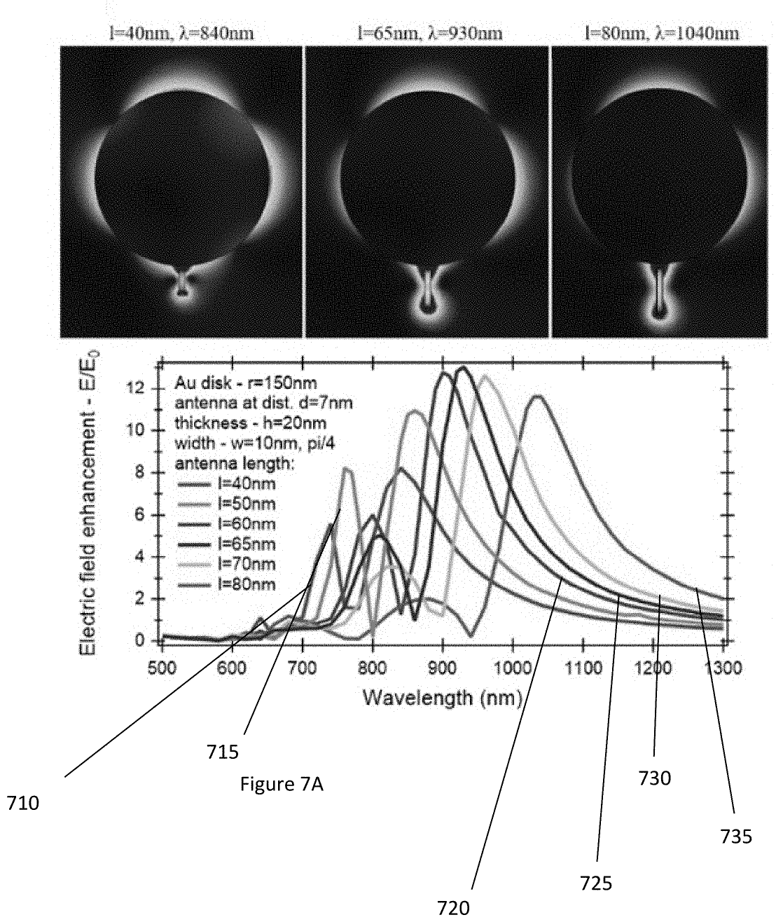

FIGS. 5 and 6 show a cross-sectional diagrams of the exemplary apparatus of FIG. 4 with a longitudinal component of the electric field coupling from a plasmonic transducer/waveguide (e.g., shown as a combined light system 505) to metallic sphere/nanoparticle 415 that can excite a localized surface plasmon of the sphere/nanoparticle 415. The hot spot 505 can be created on top of the sphere/nanoparticle 415 where recording material 410 is placed. Additionally, an electric field distribution in the sphere for a dipole nanoantenna assumption is illustrated.

### Exemplary Results

The exemplary apparatus was validated based on an exemplary configuration with the nanodisk working as a transducer and resonant dipole antenna that substituted for a patterned media. (See e.g., diagram shown in FIG. 3A). Both the transducer and resonant antenna can be designed to take advantage of not only the field enhancement from the plasmonic resonance, but also the electrostatic lightning rod effect from sharp terminations where field continuity conditions can force surface charges into a small area. In this exemplary configuration, the high field enhancement can be achieved by using a dipole antenna coupled to the termination of a nanodisk transducer across a narrow gap that can play the role of a semi-transparent mirror in a conventional Fabry-Perot interferometer. Thus, the high field enhancement at the termination of the transducer can be combined with the antenna resonance producing very strong local fields in the gap between transducer and the antenna.

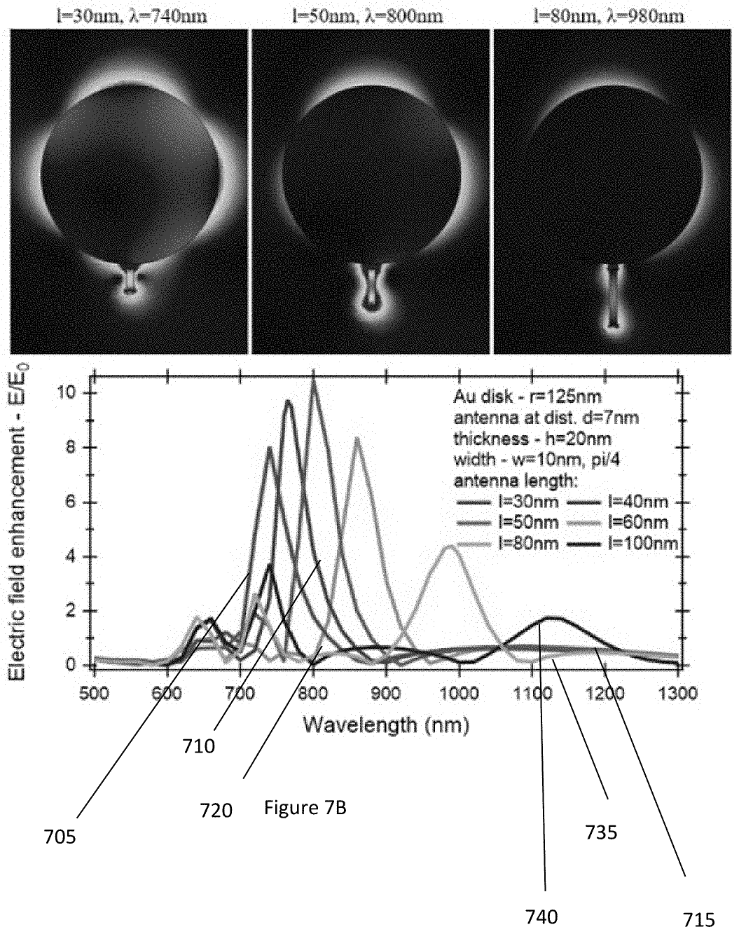

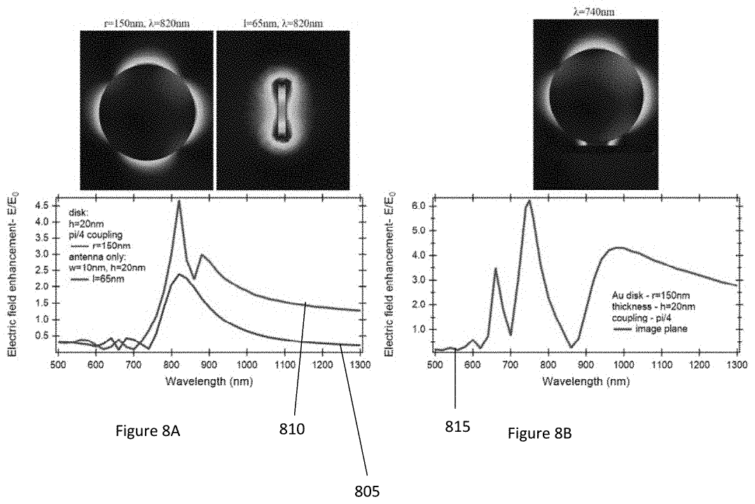

The electric field was calculated under the assumption that intensity of the incident field was I₀=1 MW/m². Thus, the amplitude of the incident electric field was calculated to be E₀=27.4·10³V/m. For h=20 nm thick and r=150 nm Au nanodisk, the electric field enhancement corresponding to a longitudinal component of the electric field reaches approximately 2.4. (See e.g., FIG. 7A). Simultaneously, the resonance excitation of 1=65 nm long antenna leads to antenna-induced field enhancement of approximately 4.6. (See e.g., FIG. 8A). Consequently, the overall intensity enhancement at the gap was calculated as 2.4²×4.6²≈121.9.

To achieve a field enhancement in the direction of either the nanoantenna or the image plane, disks in shown in the images in FIGS. 7A-8B were illuminated at angles of θ=π/2.25=80° and φ=π/4=45° (See, e.g., diagrams shown in FIGS. 3A and 3B), and for a nanorod (See e.g., images shown in FIG. 8B) the field enhancement was calculated for an electric field polarized along the long axis of the nanorod. (See e.g., diagrams shown in FIGS. 3A and 3B). An illumination angle of φ=π/4=45° for disk radii of r=125 nm (e.g., graph shown in FIG. 7B) and r=150 nm (e.g., graph shown in FIG. 7A) facilitates the achievement of high field enhancement oriented in the direction of either the nanoantenna or the image plane at a particular wavelength range of about 700-1000 nm.

In particular, the graphs shown in FIGS. 7A and 7B illustrate antenna lengths of 30 nm (line 705), 40 nm (line 710), 50 nm (line 715), 60 nm (line 720), 65 nm (line 725), 70 nm (line 730), 80 nm (line 735), and 100 nm (line 740). Wavelength dependent simulations for different disk sizes illustrated that the maximum field enhancement in the gap can depend on both the disk size and the nanoantenna length. (See e.g., images and graphs shown in FIGS. 7A and 7B). Thus, an electric field enhancement for disk radii of 125 nm and 150 nm can be achieved for nanoantenna lengths of 50 nm and 65 nm, respectively. As a result, depending on the transducer design and the supported mode, different nanoantenna dimensions can be considered to ensure maximum energy transfer to a recording media.

The simulations performed for a complex structure with a nanodisk and antenna separated by a distance of about 7 nm (e.g., about 5 nm to about 9 nm) shows a field enhancement in the gap of approximately 13.0 leading to the intensity enhancement of 169. In addition to a strong field enhancement in the gap, this local field can be highly uniform within the entire volume of the gap, providing a significant advantage over a design based on the lighting rod effect at sharp corners. That property can make it beneficial for applications in the heat-assisted magnetic recording where a high temperature gradient in the recording media can be beneficial.

FIGS. 8A and 8B show further exemplary images and associated graphs illustrating the calculated electric field according to a further exemplary embodiment of the present disclosure. Numerical simulations performed for a nanodisk with a radius of r=150 nm (line 805) and for an antenna with a length of 1=65 nm (line 810) show very high local field uniformity with an electric field enhancement of approximately 13 which can lead to an intensity enhancement of approximately 169. (See e.g., images and graph shown FIG. 7A)). At the same time, for h=20 nm thick and r=150 nm Au nanodisk, the electric field enhancement reaches approximately 2.4 (see, e.g., graph shown in FIG. 8A). Simultaneously, the resonance excitation of 1=65 nm long antenna can lead to an antenna-induced electric field enhancement of approximately 4.6. (See e.g., images and graph shown in FIG. 8A). The electric field enhancement in the gap between a nanodisk of the same dimensions and image plane (See e.g., line 815 shown in the graph of FIG. 8B) shows the electric field enhancement of approximately 6.2, which translates to the intensity enhancement of approximately 38.4. This can be almost about 4.4 times smaller compared to the structure with resonant antenna. Furthermore, the electric field strength in the gap shows much less uniformity.

A strong field enhancement in the nanodisk-antenna structure can be closely related to the excitation of the antenna. At the resonance, the electric field in the gap can reach its maximum at the wavelength of about λ=920 nm for a nanodisk with r=150 nm and antenna length of l=65 nm. An increase of the antenna length can reduce the field enhancement in the gap, and can shift it to the longer wavelengths. Alternatively, shorter antenna can blueshift the resonance wavelength of the structure.

In addition to a strong field enhancement in the gap, this local field can be highly uniform within the entire volume of the gap (see, e.g., Reference 13), providing a significant advantage over designs relying on the lightning rod effect at sharp corners. This property makes the exemplary apparatus beneficial for applications in the heat-assisted magnetic recording where uniform and high temperature in the recording media is beneficial.

For all numerical simulations, the electric field profile was taken at the distance of about 10 nm above the glass surface (i.e. in the middle of the plasmonic structures that was taken at h=20 nm). The refractive index of glass was taken as n=1.5.

The exemplary apparatus can be used with any type of plasmonic transducer/waveguide and a supported mode as long as the resonant antenna conditions can be implemented. Furthermore, it can ensure uniform electric field and consequently a uniform temperature distribution in the recording media—the property beneficial in the HAMR technology.

The exemplary apparatus can facilitate the increase of a power transfer to the recording media deposited on the patterned substrate or previously deposited metal nanoparticles of different forms and shapes, and can take full advantage of the resonant antenna conditions to achieve further intensity enhancement in the gap, and consequently high-power transfer to the recording media. For the same disk dimensions, at least a 4.4 times higher field intensity enhancement can be achieved in the recording media for a structure with a pattern media compared to the conventional HAMR design with a flat recording media. When either a patterned media can be fabricated in the form of resonant dipole antennas or the deposited nanoparticles can support a resonant mode, the longitudinal component of the electric field at the termination of the plasmonic transducer/waveguide can couple to the antenna across a gap that can give rise to the field intensity. Under the resonant conditions between the plasmonic transducer/waveguide and the patterned media/resonant antenna formed either by structuring the media bellow the recording material or by deposition of metallic nanoparticles below a recording media, the further enhancement of the intensity field can be observed. Furthermore, the exemplary apparatus can facilitate a superior impedance match between plasmonic transducer/waveguide and a resonant antenna giving rise to the energy transfer to the recording media. This can be beneficial for HAMR technology as it can facilitate a reduction in energy consumption to the record data disc.

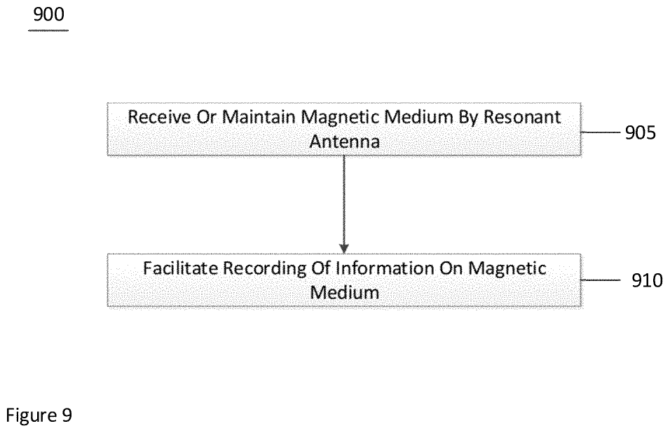

FIG. 9 shows an exemplary flow diagram of an exemplary method 900 for recording information on a magnetic medium according to an exemplary embodiment of the present disclosure. For example, at procedure 905 a magnetic medium can be received or maintained by a resonant antenna, where the resonant antenna can be spaced at a distance from a transducer or a waveguide. At procedure 910, recording of the information on the magnetic medium can be facilitated.

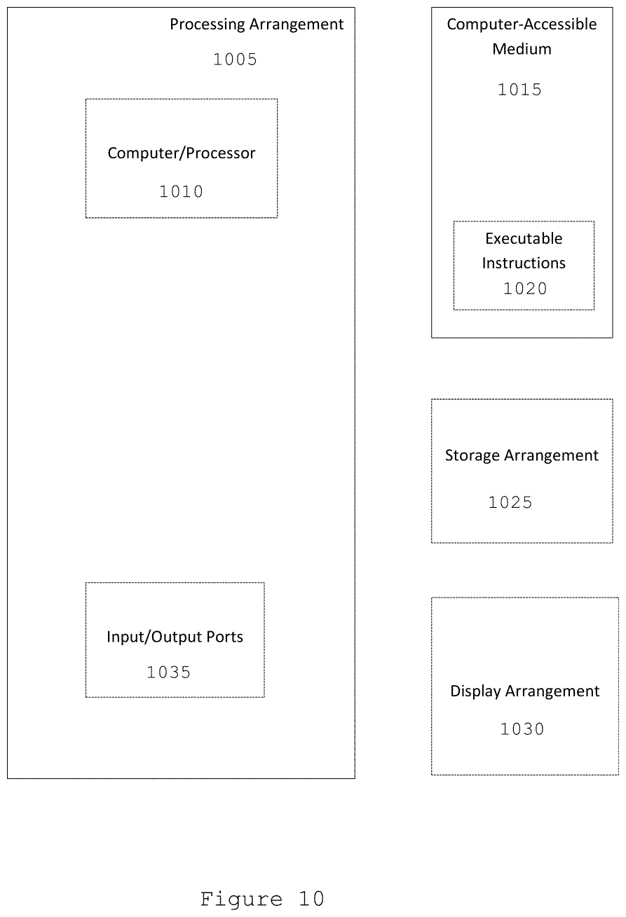

FIG. 10 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 1005. Such processing/computing arrangement 1005 can be, for example entirely or a part of, or include, but not limited to, a computer/processor 1010 that can include, for example one or more microprocessors, and use instructions stored on a computer-accessible medium (e.g., RAM, ROM, hard drive, or other storage device).

As shown in FIG. 10, for example a computer-accessible medium 1015 (e.g., as described herein above, a storage device such as a hard disk, floppy disk, memory stick, CD-ROM, RAM, ROM, etc., or a collection thereof) can be provided (e.g., in communication with the processing arrangement 1005). The computer-accessible medium 1015 can contain executable instructions 1020 thereon. In addition or alternatively, a storage arrangement 1025 can be provided separately from the computer-accessible medium 1015, which can provide the instructions to the processing arrangement 1005 so as to configure the processing arrangement to execute certain exemplary procedures, processes, and methods, as described herein above, for example.

Further, the exemplary processing arrangement 1005 can be provided with or include an input/output ports 1035, which can include, for example a wired network, a wireless network, the internet, an intranet, a data collection probe, a sensor, etc. As shown in FIG. 10, the exemplary processing arrangement 1005 can be in communication with an exemplary display arrangement 1030, which, according to certain exemplary embodiments of the present disclosure, can be a touch-screen configured for inputting information to the processing arrangement in addition to outputting information from the processing arrangement, for example. Further, the exemplary display arrangement 1030 and/or a storage arrangement 1025 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entireties:
1. S. A. Maier, and H. A. Atwater, “Plasmonics: Localization and guiding of electromagnetic energy in metal/dielectric structure,” J. of Appl. Phys. 98(1), 011101 (2005).
2. W. L. Barnes, A, Dereux, and T. W. Ebbesen, “Surface plasmon subwavelength optics,” Nature 424, 824-830 (2003).
3. E. Ozbay, “Plasmonics: Merging photonics and electronics at nanoscale dimensions,” Science 311, 189-193 (2006).
4. J. B. Khurgin, and A. Boltasseva, “Reflecting upon the losses in plasmonics and metamaterials,” MRS Bull. 37, 768-779 (2012).
5. P. Muhlschlegel, H.-J. Eisler, O. J. F. Martin, B. Hecht, and D. W. Pohl, “Resonant Optical Antennas,” Science 308, 1607-1608 (2005).
6. P. Bharadwaj, B. Deutsch, and L. Novotny, “Optical Antennas,” Adv. in Opt. and Phot. 1, 438-483 (2009).
7. V. Giannini, A. I. Fernandez-Dominguez, S. C. Heck, and S. A. Maier, “Plasmonic Nanoantennas: Fundamentals and Their Use in Controlling the Radiative Properties of Nanoemitters,” Chem. Rev. 111, 3888 3912 (2011).
8. J. A. Schuller, E. S. Barnard, W. Cai, Y. Chul Jun, J. S. White, and M. L. Brongersma, “Plasmonics for extreme light concentration and manipulation,” Nat. Mat. 9, 193-204 (2010).
9. D. K. Gramotnev, A. Pors, M. Willatzen, and S. I. Bozhevolnyi, “Gap-plasmon nanoantennas and bowtie resonators,” Phys. Rev. B 85, 045434 (2012).
10. A. Portela, T. Yano, Ch. Santschi, H. Matsui, T. Hayashi, M. Hara, O. J. F. Martin, and H. Tabata, “Spectral tenability of realistic plasmonic nanoantennas, App. Phys. Lett. 105, 091105 (2014).
11. R. Esteban, G. Aguirregabiria, A. G. Borisov, Y. M. Wang, P. Nordlander, G. W. Bryant, and J. Aizpurua, “The Morphology of Narrow Gaps Modifies the Plasmonic Response,” ACS Photon. 2, 295-305 (2015).
12. H. Fischer, and O. J. F. Martin, “Engineering the optical response of plasmonic nanoantennas,” Opt. Express 16(12), 9144-9154 (2008).
13. V. A. Zenin, A. Andryieuski, R. Malureanu, I. P. Radko, V. S. Volkov, D. K. Gramotnev, A. V. Lavrinenko, and S. I. Bozhevolnyi, “Boosting Local Field Enhancement by on-Chip Nanofocusing and Impedance-Matched Plasmonic Antennas,” Nano Lett. 15, 8148-8154 (2015).
14. W. A. Challener, Ch. Peng, A. V. Itagi, D. Karns, W. Peng, Y. Peng, X. M. Yang, X. Zhu, N. J. Gokemeijer, Y.-T. Hsia, R. E. Rottmayer, M. A. Seigler, and E. C. Gage, “Heat-assisted magnetic recording by a near-field transducer with efficient optical energy transfer,” Nature Photon. 3, 220-224 (2009).
15. B. C. Stipe, T. C. Strand, C. C. Poon, H. Balamane, T. D. Boone, J. A. Katine, J.-L. Li, V. Rawat, H. Nemoto, A. Hirotsune, O. Hellwig, R. Ruiz, E. Dobisz, D. S. Kercher, N. Robertson, T. R. Albrecht, B. D. Terris, “Magnetic recording at 1.5 Pb m-2 using an integrated plasmonic antenna,” Nature Photon. 4, 484-488 (2010).
16. N. Zhou, X. Xu, A. T. Hammack, B. C. Stipe, K. Gao, W. Scholz and E. C. Gage, “Plasmonic near-field transducer for heat-assisted magnetic recording,” Nanophotonics 3(3), 141-155 (2014).
17. J. Gosciniak, M. Mooney, M. Gubbins and B. Corbett, “Novel Mach-Zehnder Interferometer waveguide as a light delivery system for a heat assisted magnetic recording”, IEEE Transactions on Magnetics 52(2), 3000307 (2015).
18. J. Gosciniak, M. Mooney, M. Gubbins and B. Corbett, “Novel droplet near-field transducer for a heat-assisted magnetic recording”, Nanophotonics 4(1), 503-510 (2015).
19. http://www.comsol.com/products/4.3a/
21. J. Gosciniak, J. Justice, U. Khan, M/Modreanu and B. Corbett, “Study of higher order plasmonic modes on ceramic nanodisks,” Optics Express 25(5), 5244-5254, (2017).
22. J. Gosciniak, J. Justice, U. Khan and B. Corbett, “Study of TiN nanodisks with regard to application for Heat-Assisted Magnetic Recording,” MRS Advances 1(5), 317-326 (2016).
23. K. Li, M. I. Stockman and D. J. Bergman, “Slef-Similar Chain of Metal Nanospheres as an Efficient Nanolens,” Phys. Rev. Letters 91(22), 227402-4 (2003).

What is claimed is:

1. An apparatus for recording information on a magnetic medium, comprising:
at least one of (i) at least one transducer or (ii) at least one waveguide; and
at least one resonant antenna spaced at a distance from the at least one of (i) the at least one transducer or (ii) the at least one waveguide, wherein the at least one resonant antenna is configured to receive or maintain the magnetic medium thereon

2. The apparatus of claim 1, wherein the at least one resonant antenna includes at least one of (i) a plurality of nanotubes (ii) a plurality of nanorods or (iii) a plurality of nanospheres.

3. The apparatus of claim 2, wherein a size of the at least one of (i) the plurality of nanotubes (ii) the plurality of nanorods or (iii) the plurality of nanospheres is based on an impedance of the at least one of (i) the at least one transducer or (ii) the at least one waveguide.

4. The apparatus of claim 1, wherein the at least one resonant antenna includes a plurality of metallic nanoparticles configured to support at least one localized surface plasmon.

5. The apparatus of claim 1, wherein the distance is about 7 nanometers.

6. The apparatus of claim 1, wherein the at least one transducer is at least one plasmonic transducer.

7. The apparatus of claim 1, wherein the at least one waveguide is at least one plasmonic waveguide.

8. The apparatus of claim 1, wherein the apparatus includes the at least one transducer and the at least one waveguide.

9. The apparatus of claim 8, wherein the at least one transducer is supported by the at least one waveguide.

10. The apparatus of claim 9, wherein the at least one transducer and the at least one waveguide are supported by a substrate.

11. The apparatus of claim 1, wherein the at least one resonant antenna is disposed on an underlayer, and wherein the underlayer is disposed on a substrate.

12. The apparatus of claim 1, wherein the at least one transducer has a shape of a disk.

13. The apparatus of claim 1, wherein the at least one transducer has a tapered end located on a side of the at least one transducer that is adjacent to the at least one resonant antenna.

14. The apparatus of claim 1, wherein the at least one resonant antenna includes a plurality of resonant antennas, and wherein each of the resonant antennas is configured to at least one of receive or maintain a portion of the magnetic medium thereon.

15. The apparatus of claim 1, wherein the at least one resonant antenna is at least partially composed of at least one of (i) gold or (ii) a metallic material.

16. The apparatus of claim 1, wherein the magnetic medium is a recording medium.

17. The apparatus of claim 1, wherein the apparatus has a uniform field distribution between (i) the at least one of the at least one transducer or the at least one waveguide and (ii) the at least one resonant antenna.

18. The apparatus of claim 1, wherein the magnetic medium is a patterned medium.

19. An apparatus for recording information on a magnetic medium, comprising:
at least one transducer disposed on at least one waveguide;
a substrate configured to support an underlayer;
a plurality of resonant antennas disposed on the underlayer and spaced apart from one another; wherein the resonant antennas are spaced apart from one another at a predetermined distance from the at least one transducer and the at least one waveguide, and wherein the resonant antennas are configured to at least one of receive or maintain a magnetic recording medium thereon.

20. A method for recording information on a magnetic medium, comprising:
receiving or maintaining the magnetic medium by at least one resonant antenna, wherein the at least one resonant antenna is spaced at a distance from at least one of (i) at least one transducer or (ii) at least one waveguide; and
facilitating the recording of the information on the magnetic medium.
